(19) United States
(12) Patent Application Publication
(10) Pub. No.: US 2011/0000100 A1
(43) Pub. Date: Jan. 6, 2011

(54) LAUNDRY TREATMENT APPLIANCE COMPRISING A DRUM AND A SENSOR, AND METHOD FOR THE OPERATION THEREOF

(75) Inventors: Stephan Malcher, Berlin (DE); Harald Pietsch, Berlin (DE); Martina Wöbkemeier, Berlin (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/920,336

(22) PCT Filed: Mar. 9, 2009
(86) PCT No.: PCT/EP2009/052742

§ 371 Date: Aug. 31, 2010

(30) Foreign Application Priority Data
Mar. 11, 2008 (DE) 10 2008 013 557.7

(51) Int. Cl. F26B 3/00; D06F 58/04; F26B 19/00

(52) U.S. Cl. 34/499; 34/108; 34/89

(57) ABSTRACT

A laundry treatment appliance having a drum; a motor to drive the drum; a control device, in which an acoustic reference signal is stored; an acoustic sensor to measure an acoustic signal; and a comparator to compare the acoustic signal recorded by the acoustic sensor with the acoustic reference signal stored in the control device; wherein each of the acoustic signal and the acoustic reference signal is a sonogram.

The invention relates to a laundry treatment appliance comprising a drum and a sensor, in particular for regulating the rotational speed, and to a method for the operation thereof. In particular, the invention relates to a laundry treatment appliance comprising a sensor, which appliance may be embodied as a washing machine, washer dryer or dryer, and to a method for the operation thereof.

In a laundry treatment appliance comprising a drum, various noises occur during operation, the nature and extent of which depend on the operating state and/or the process stage in a laundry treatment method and on the condition, in particular the ageing condition, of the appliance and its components.

For example, in a dryer comprising a drum, a relatively loud noise can be heard at the start of the drying process due to the movement, in particular due to the falling, of wet laundry (“laundry slapping”) in the rotating drum, since as a rule a rotational speed of approx. 55 revolutions per minute (rpm) is set for the drum. A similar problem occurs when clothing items with zips are present in the drum. It would therefore be desirable initially to dry at a higher rotational speed almost equal to the speed at which the laundry is forced against the wall of the drum and to reduce the rotational speed to the otherwise optimal lower range only when the moisture content of the laundry is lower. In this way, a significant reduction in the noise level could be achieved.

In a washing machine, on the other hand, a high noise level (sound level) can be caused by imbalance of the drum during spinning. Too great an imbalance can be clearly heard. The sleeve deforms differently from the way in which it deforms when spinning with a small imbalance and in doing so emits noises, as do the springs and dampers of the vibrating system comprising the drum.

Furthermore, different operating states of a laundry treatment appliance can be recognized from the noises associated with them. Thus, the noise during pumping with water is lower than that during pumping at no load. Pumping against foam also sounds different.

US 2003/0037382 A1 relates to a washing machine with a built-in noise reduction system, which contains a microphone for audibly detecting at least an out-of-balance or pump-starvation condition and a controller for altering the washing operation based on the signals received from the microphone. The microphone can in principle be mounted anywhere in the washing machine, the microphone generally constituting an acoustic signal transducer that generates an electric signal in response to measured acoustic energy. An electric condenser microphone is mentioned as an example. The signals received from the microphone can be analyzed by a CPU for an out-of-balance or a pump-starvation condition, whereupon, for example, the rotational speed of the drum of the washing machine can be adjusted.

JP 2007-167175 A describes a washing machine which, besides a rotatable drum for accommodating laundry, has a microphone for recording acoustic vibration signals which are generated by the drum and a comparison part for comparing the result determined by the microphone with reference data for various preset washing states. In addition, a drum rotation control part is used for controlling the washing state of the laundry. Periodic fluctuations in the noise level due to rotation of the drum are registered and compared with the reference data, whereupon the wash process is controlled accordingly.

JP 2007/143630 A describes a washing machine which is fitted with a vibration sensor which measures vibrations of a special body, a sensor for transmission noises which measures the noises caused by the vibrations, and a control means for analyzing the information from the vibration sensor and the noise sensor in order to control the rotation of a drive motor.

The recording and analysis of acoustic signals in the known washing machines, however, present disadvantages e.g. with regard to the accuracy of the recording and the simplicity of the analysis.

The object of the present invention has therefore been to provide a laundry treatment appliance and a method for the operation thereof which permit optimum control of the rotational speed of a drum.

This object is achieved according to this invention in a laundry treatment appliance having the features of the respective independent claim. Preferred embodiments of the inventive laundry treatment appliance and of the inventive method are presented in corresponding dependent claims. Preferred embodiments of the inventive method correspond to preferred embodiments of the inventive laundry treatment appliance and vice versa, even if this is not indicated in each individual case.

The subject matter of the invention is thus a laundry treatment appliance comprising a drum, a motor for driving the drum, a control device and a sensor, the sensor being an acoustic sensor for measuring an acoustic signal and the laundry treatment appliance having means for comparing the acoustic signal recorded by the acoustic sensor with an acoustic reference signal stored in the control device, and the acoustic signal and the acoustic reference signal being in each case a sonogram.

A sonogram is understood here to be a two-dimensional representation in which a rapidly changing acoustic process is represented as a relatively slow change over time of a spectrum of relatively high frequencies. The sonogram is thus a kind of partial Fourier transformation of an acoustic signal, the time representation being retained with respect to lower-frequency portions of the signal, but a transformation into the frequency representation being carried out with respect to higher-frequency portions.

Acoustic sensors as such are generally known, for example as microphones.

The acoustic sensor can preferably carry out a frequency-selective measurement of a sound level. Acoustic sensors can operate in a wide frequency range. According to the invention, it is preferable if the acoustic sensor can measure sound-level changes in a frequency range from 30 Hz to 30 kHz.

The inventive use of an acoustic sensor makes it possible to monitor and control the programs running in a laundry treatment program. In addition, the acoustic signal measured by the acoustic sensor can also be used for monitoring the proper functioning of a laundry treatment appliance. For example, faults or signs of ageing in the laundry treatment appliance can be detected so that suitable remedial measures can be introduced.

For example, a material fracture can be indicated on the basis of characteristic noises such as cracking or tearing. In addition to these, other noises such as hissing, whistling, whooshing, grinding, humming, droning, banging, knocking etc. can be identified and analyzed appropriately. An acoustic sensor could thus also detect leakage noises (discharge of water in the case of a washing machine) or imbalances.

The acoustic signal is registered in the form of a sonogram.

In an acoustic sensor, the frequency range, sensitivity, signal smoothing, switching threshold and/or output characteristics can generally be adjusted.

The laundry treatment appliance according to the invention is preferably a washing machine, a washer dryer or a dryer. In a particularly preferred embodiment, the laundry treatment appliance is a washing machine or a washer dryer.

The acoustic sensor can be arranged at various points in the laundry treatment appliance. Furthermore, a plurality of acoustic sensors can optionally be used. A suitable point for the arrangement of the acoustic sensor will generally depend on the purpose for which the acoustic signals to be measured with the acoustic sensor are to be used. If the focus is on monitoring the processes in a drum, for example the drum in a dryer, it will be useful to arrange the acoustic sensor in or near to the drum. If the functioning of a pump, in particular, is to be monitored, an arrangement on the pump is advantageous.

It will generally be useful to arrange the acoustic sensor such that the acoustic signals from a plurality of components of a laundry treatment appliance can be measured and analyzed.

In a preferred embodiment of the inventive laundry treatment appliance, the acoustic sensor is arranged in or on a detergent-solution container of a washing machine or of a washer dryer.

It is in turn preferable here for the acoustic sensor to be arranged on a pump of the washing machine or of the washer dryer. This makes control of the pump possible. The noise or sound level during the pumping of water is lower than during pumping at no load, when no water is present. The noise when foam is being pumped against is also different. The invention can therefore provide that when measuring an acoustic signal that differs to a predefined extent from a predefined average sound level, the pump is halted or, in the case of a controllable pump, the rotational speed of the pump is changed.

If the inventive laundry treatment appliance is a washing machine or a washer dryer, the acoustic sensor is in a further preferred embodiment arranged on a sleeve.

In a further preferred embodiment, the inventive laundry treatment appliance is a dryer or a washer dryer. In this case the acoustic sensor is preferably mounted on the drum. Alternatively or in addition to this, an acoustic sensor can be arranged on a condensate container which may optionally be present.

In a dryer which is fitted with a heat exchanger, the condensate container is normally located below the heat exchanger.

In further preferred embodiments of an inventive laundry treatment appliance fashioned as a dryer or washer dryer, one or more acoustic sensors are arranged in the region of the motor and/or on the control device.

The inventive laundry treatment appliance generally also has a heater. In a dryer, for example, a heater is used for heating process air prior to the introduction of said air into the drum functioning as a drying chamber. The heater in a supply-air duct of a dryer may, for example, be an electric heater (electric resistance heater), a gas heater and/or one or more heat exchangers. The heater preferably comprises a gas or electric heater.

Additionally, in a dryer, at least one heat exchanger (air-to-air heat exchanger, heat source or heat sink, in particular a condenser or evaporator of a heat pump) may also be present in order to reduce energy losses though heat recovery. Where heat exchangers are used, the supply-air duct and the exhaust-air duct which carries the hot air out of the drying chamber generally cross.

The inventive laundry treatment appliance has means for comparing the acoustic signal recorded by the acoustic sensor with an acoustic reference signal stored in the control device of the laundry treatment appliance, the acoustic signal and the acoustic reference signal being in each case a sonogram. A sonogram within the meaning of the invention is a sound spectrogram which describes a relationship between individual frequencies and the intensity of the sound and the course thereof over time.

According to the invention, it is preferable for the acoustic reference signal to comprise admissible combinations of values for these frequencies and sound intensities and the course thereof over time.

The laundry treatment appliance preferably has a display means for reproducing the measured acoustic signal of the acoustic sensor. This is generally an optical display. The display means can display the operating state and/or a malfunction of the laundry treatment appliance.

Furthermore, the display device can be used only for visualizing the noises generated by the laundry treatment appliance.

Depending on the nature and scope of the acoustic signal to be reproduced and on the number of acoustic sensors, the display means may comprise one part or several parts.

The reproduction in the display may, for example, be implemented in the form of numerical values, different colors or a bar diagram. For example, different colors (e.g. green and red) may indicate regular or defective states of the laundry treatment appliance.

The invention also relates to a method for operating a laundry treatment appliance comprising a drum, a motor for driving the drum, a control device and an acoustic sensor, the acoustic sensor measuring at one or more frequencies during operation of the laundry treatment appliance an acoustic signal, in particular a sound level, a sonogram being measured as the acoustic signal.

The measured acoustic signal is preferably compared with a reference signal stored in the control device.

If the laundry treatment appliance is a washing machine or a washer dryer, the acoustic signal measured by the acoustic sensor is in the inventive method preferably compared with a reference signal stored in the control device.

In a preferred embodiment, when in a spinning step of the washing machine or of the washer dryer a predefined value ΔSᵥ¹ for a difference ΔS between the measured acoustic signal and the reference signal for a spinning step stored in the control device is exceeded, a rotational speed of the drum is reduced until said difference ΔS reaches or falls below the predefined value ΔSᵥ¹. The effect of an imbalance of the drum can be reduced by this means.

In a further preferred embodiment, when in a pumping step a predefined value ΔSᵥ² for a difference ΔS between the measured acoustic signal and the reference signal for a pumping step stored in the control device is exceeded, a rotational speed of the drum is reduced until said difference ΔS reaches or falls below this predefined value ΔSᵥ² or the pump is switched off.

In an alternative embodiment of the inventive method, in which the laundry treatment appliance is a dryer, the acoustic signal measured by the acoustic sensor is compared with a reference signal stored in the control device such that when a predefined value ΔSᵥ³ for a difference ΔS between the measured acoustic signal and a reference signal stored in the control device is exceeded, a rotational speed of the drum is increased until said difference ΔS reaches or falls below the predefined value ΔSᵥ³. In this way, noises due to the movement or falling of wet laundry or from laundry items having zips can be reduced.

The inventive laundry treatment appliance and the inventive method for the operation thereof have the advantage that the noises associated with the operation of a laundry treatment appliance comprising a drum can be used for controlling the operation and for monitoring the laundry treatment appliance and the components thereof.

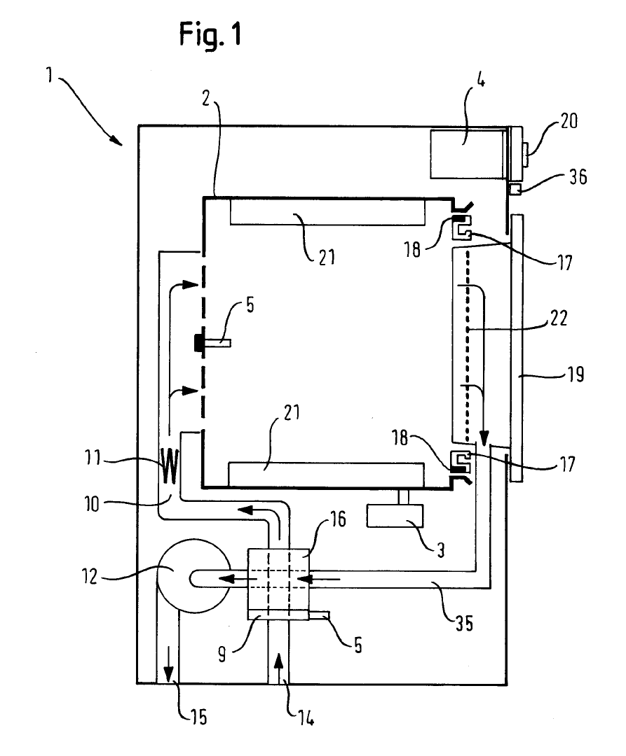

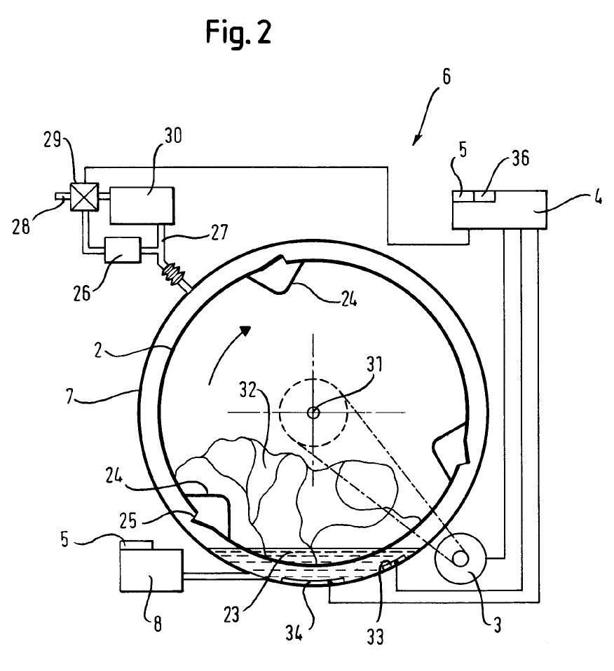

Further details of the invention will emerge from the description below of non-restrictive exemplary embodiments of the inventive laundry treatment appliance and of the method for the operation thereof, with reference being made to FIGS. 1 and 2. Other embodiments are conceivable.

FIG. 1 shows a vertical section through a first embodiment of a laundry treatment appliance fashioned as an exhaust-air dryer.

FIG. 2 shows schematically a vertical section through a second embodiment of a laundry treatment appliance fashioned as a washing machine.

The exhaust-air dryer 1 according to a first embodiment represented in FIG. 1 has a drum 2 rotatable about a horizontal axis as a drying chamber 2 inside which entrainment means 21 are fixed for moving laundry during a rotation of the drum. Process air is guided by means of a fan 12 over a heater 11 through the drum 2 in a process-air duct 10. Ambient air is supplied into the process-air duct 10 via a supply-air duct 14 or sucked in by means of the fan 12. After passing through the drum 2, the process air which is now moist and warm enters an exhaust-air duct 35. Located in the exhaust-air duct 35 is an air-to-air heat exchanger 16 in which the process air (here exhaust air) is cooled and, after the moisture contained in it has condensed, is guided to the exhaust-air outlet 15.

In particular, air heated by the heater 11 is conducted from the back, i.e. the side of the drum 2 opposite a door 19, through the perforated base thereof into the drum 2, comes into contact there with the laundry to be dried and flows through the filling opening of the drum 2 to a lint filter 22 inside a door 19 which closes the filling opening. The process-air flow is then deflected downward in the door 19. The process air is fed in the exhaust-air duct 35 to an air-to-air heat exchanger 16 in which the warm, moisture-laden process air is cooled and subsequently guided to an exhaust-air outlet 15. The separated moisture is collected in a condensate collection container 9, from where it can be removed, for example by pumping by means of a condensate pump (not shown here).

Ambient air fed to the dryer 1 via the supply-air duct 14 is used in the air-to-air heat exchanger 16 for cooling. This supply air is heated by the warm moisture-laden process air and, prior to entry into the drum 2, is then heated again by means of the heater 11.

The drum 2 is supported in the embodiment shown in FIG. 1 on the base at the rear by means of a rotation bearing and at the front by means of a bearing shield 17, the drum 2 resting with a flange on a glide strip 18 on the bearing shield 17 and being held at the front end in this way. A motor 3 drives the drum 2. Control of the exhaust-air dryer 1 is effected via a control device 4 which can be controlled by the user via an operating unit 20. 36 signifies a display means for reproducing the acoustic signal measured by the acoustic sensor.

In the embodiment shown in FIG. 1, acoustic sensors 5 are located inside the drum 2 and on the condensate collection container 9.

FIG. 2 shows schematically a vertical section though a second embodiment of a laundry treatment appliance fashioned as a washing machine.

FIG. 2 is, in particular, a schematic representation of the presently relevant parts of a washing machine 6 in which a method described herein can be executed. The washing machine 6 of the embodiment shown in FIG. 2 has a detergent-solution container 7 in which a drum 2 can be rotatably supported and run by a motor 3. According to recent findings with respect to the ergonomics of working with such washing machines, the rotational axis 31 of the drum 2 is frontwardly oriented upwardly out of the horizontal by a small angle (e.g. 13°) so as to facilitate access and inspection of the interior of the drum 2. This arrangement also achieves, in interaction with specially shaped laundry entrainers 24 and scooping devices 25 for the washing detergent solution 23 on the inner surface of the drum casing, an intensified through-flow of washing detergent solution through the laundry 32.

The washing machine also has a detergent-solution feed system which comprises a water supply fitting for the domestic water mains 28, an electrically controllable valve 29 and a feed line 27 to the detergent-solution container 7 which runs via a flushing-in tray 30 from which the supply water can transport portions of washing agent into the detergent-solution container 7. A dosing device 26 enables, in interaction with the domestic water mains 28, the supply of fabric softener into the detergent-solution container 7. Also located in the detergent-solution container 7 is a heating device 34. The valve 29 and the heating device 34 can be controlled by means of a control device (program controller) 4 according to a program flow schedule which can be tied to a time program and/or to the achievement of certain measurement values of parameters such as detergent-solution level, detergent-solution temperature, rotational speed of the drum 2 etc. inside the washing machine. 33 signifies a sensor for measuring the hydrostatic pressure p in the detergent-solution container 7. 8 signifies a pump for the liquid located in the detergent-solution container 7.

In the embodiment from FIG. 2, acoustic sensors 5 are arranged on the pump 8 and on the control device 4. 36 signifies a display means for reproducing the measured acoustic signal.

1-19. (canceled)

20. A laundry treatment appliance, comprising:
a drum;
a motor to drive the drum;
a control device, in which an acoustic reference signal is stored;
an acoustic sensor to measure an acoustic signal; and
a comparator to compare the acoustic signal recorded by the acoustic sensor with the acoustic reference signal stored in the control device;
wherein each of the acoustic signal and the acoustic reference signal is a sonogram.

21. The laundry treatment appliance of claim 20, wherein the acoustic sensor carries out a frequency-selective measurement of a sound level.

22. The laundry treatment appliance of claim 20, wherein the laundry treatment appliance is one of a washing machine, a washer dryer, and a dryer.

23. The laundry treatment appliance of claim 22, wherein the laundry treatment appliance is one of the washing machine and the washer dryer.

24. The laundry treatment appliance of claim 23, wherein the acoustic sensor is arranged in a detergent-solution container of the one of the washing machine and the washer dryer.

25. The laundry treatment appliance of claim 23, wherein the acoustic sensor is arranged on a pump.

26. The laundry treatment appliance of claim 23, wherein the acoustic sensor is arranged on a sleeve.

27. The laundry treatment appliance of claim 22, wherein the laundry treatment appliance is one of the dryer and the washer dryer.

28. The laundry treatment appliance of claim 27, wherein the acoustic sensor is arranged on a drum.

29. The laundry treatment appliance of claim 27, wherein the acoustic sensor is arranged on a condensate container.

30. The laundry treatment appliance of claim 27, wherein the acoustic sensor is arranged in a region of the motor.

31. The laundry treatment appliance of claim 20, wherein the acoustic sensor is arranged on the control device.

32. The laundry treatment appliance of claim 20, further comprising a display to reproduce the measured acoustic signal of the acoustic sensor.

33. A method for operating a laundry treatment appliance having a drum, a motor for driving the drum, a control device and an acoustic sensor, wherein the acoustic sensor measures an acoustic signal on at least one frequency, and wherein the acoustic signal is a sonogram.

34. The method of claim 33, wherein the measured acoustic signal is compared with a reference signal stored in the control device.

35. The method of claim 34, wherein the laundry treatment appliance is one of a washing machine and a washer dryer.

36. The method of claim 35, wherein, when in a spinning step a predefined value ΔSᵥ¹ for a difference ΔS between the measured acoustic signal and the reference signal for the spinning step stored in the control device is exceeded, a rotational speed of the drum is reduced until the difference ΔS one of reaches and falls below the predefined value ΔSᵥ¹.

37. The method of claim 35, wherein, when in a pumping step a predefined value ΔSᵥ² for a difference ΔS between the measured acoustic signal and the reference signal for the pumping step stored in the control device is exceeded, one of the rotational speed of the drum is reduced until the difference ΔS one of reaches and falls below the predefined value ΔSᵥ² and the pump is switched off.

38. The method of claim 33, wherein the laundry treatment appliance is a dryer; wherein the acoustic signal measured by the acoustic sensor is compared with a reference signal stored in the control device such that when a predefined value ΔSᵥ³ for a difference ΔS between the measured acoustic signal and the reference signal is exceeded, a rotational speed of the drum is increased until the difference ΔS one of assumes and falls below the predefined value ΔSᵥ³.
